(19) United States
(12) Patent Application Publication
(10) Pub. No.: US 2009/0021900 A1
(43) Pub. Date: Jan. 22, 2009

(54) PORTABLE ELECTRONIC DEVICE WITH DISPLAY ARRANGEMENT FOR CLOSED CONFIGURATION

(76) Inventors: William O. Camp, JR., Chapel Hill, NC (US); Toby J. Bowen, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/778,128

(22) Filed: Jul. 16, 2007

(51) Int. Cl. G06F 1/16

(52) U.S. Cl. 361/681

(57) ABSTRACT

An electronic device may include a display for displaying information. A housing of the electronic device may have a first section and a second section. The housing sections may be movable with respect to one another such that the electronic device has an open configuration and a closed configuration. The second housing section may retain the display and the first housing section covers an image surface of the display when the electronic device is in a closed configuration. An optical system may be arranged with respect to the display to allow a user of the electronic device to view the displayed information through the housing when the electronic device is in the closed configuration.

### TECHNICAL FIELD OF THE INVENTION

The technology of the present disclosure relates generally to portable electronic devices and, more particularly, to a system and method for displaying information to a user of the portable electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Some portable electronic devices are arranged to fold or slide into a closed configuration. In the closed configuration, a display that may be used to display information (e.g., text and/or graphics) to a user may be covered by a portion of the device. Therefore, in the closed configuration, any information displayed on the display will not be visible to the user of the device. For example, many “clamshell” mobile telephones include a display on an inside of an openable member to display information to the user when the mobile telephone is in an open configuration. The display is hidden from view when the mobile telephone is in a closed configuration.

Even in the closed configuration, however, it may be desirable to present information to the user. For this purpose, a second display may be present on an outside of the openable member to display information to the user when the mobile telephone is in either the open configuration or the closed configuration. Information displayed on the second display may include, for example, a telephone number or name associated with an incoming call, a date and time, battery condition, signal strength and so forth.

### SUMMARY

To enhance the display features of mobile telephones and other portable electronic devices, the present disclosure describes an improved display arrangement and method of displaying information to a user. In one embodiment, the electronic device has a closed configuration. While in the closed configuration, information may be displayed on a display that is covered by a portion of the electronic device. Light emitted from the display is directed through the electronic device for viewing by the user. For instance, an optical pathway through the electronic device may be present for the user to see the display. In this arrangement, innovative and interesting physical arrangements for the electronic device may be employed. Also, a second display may be eliminated since information may be displayed to the user even though the electronic device is in a closed configuration. For example, if the electronic device is a mobile telephone, a telephone number of caller may be displayed to the user without the use of a second display and without opening the mobile telephone, which is an action typically associated with answering an incoming telephone call.

According to one aspect of the disclosure, an electronic device includes a display for displaying information; a housing having a first section and a second section, the housing sections movable with respect to one another such that the electronic device has an open configuration and a closed configuration, wherein the second housing section retains the display and the first housing section covers an image surface of the display when the electronic device is in a closed configuration; and an optical system arranged with respect to the display to allow a user of the electronic device to view the displayed information through the housing when the electronic device is in the closed configuration.

According to one embodiment of the electronic device, light from the display enters the first housing section through an inner surface of the first housing section and the optical system includes a least one reflecting surface retained by the first housing section to redirect the light from the display, the redirected light exiting the first housing section for viewing by the user.

According to one embodiment of the electronic device, the optical system includes two reflecting surfaces retained by the first housing section such that light from the display is directed out of the first housing section through the inner surface of the first housing section.

According to one embodiment of the electronic device, the light that is directed out of the first housing passes through an optical channel of the second housing section.

According to one embodiment of the electronic device, the at least one reflecting surface is a mirror or mirrors.

According to one embodiment of the electronic device, the at least one reflecting surface is a prism or prisms.

According to one embodiment of the electronic device, the at least one reflecting surface is comprised of a Porro prism.

According to one embodiment of the electronic device, the at least one reflecting surface includes a curved reflecting surface to enlarge an appearance of the displayed information.

According to one embodiment of the electronic device, the optical system includes an optical element to enlarge an appearance of the displayed information.

According to one embodiment of the electronic device, the optical system includes a window through which the light passes to enter the first housing section.

According to one embodiment of the electronic device, the light is directed out of the first housing section through the window.

According to one embodiment of the electronic device, the optical system includes a second window through which the light is directed out of the first housing section.

According to one embodiment of the electronic device, light from the display enters the first housing section through an inner surface of the first housing section and is directed by the optical system to be incident on a viewing surface for viewing by the user.

According to one embodiment of the electronic device, wherein light from the display enters the first housing section through an inner surface of the first housing section, traverses the first housing section through a channel and exits the first housing section through an outer surface of the first housing section.

According to one embodiment of the electronic device, the optical system is retained in the channel and includes an optical element to enlarge an appearance of the displayed information.

According to one embodiment of the electronic device, the display includes a segmented light source having a first light source segment that provides light when the electronic device is in the open configuration and does not provide light when the electronic device is in the closed configuration and a second light source segment that provides light when the electronic device is in both the open and closed configurations.

According to one embodiment of the electronic device, the display is controlled to display information in an orientation that is coordinated with the optical system such that the displayed information has a forward appearance when viewed by the user.

According to one embodiment of the electronic device, the electronic device is a mobile telephone and includes circuitry for establishing a call over a network.

According to one embodiment of the electronic device, the circuitry includes an antenna and the antenna is positioned adjacent to the optical system so that an optical pathway for light from the display is shared with a volume surrounding the antenna that is clear of substantial electromagnetic loads.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic cross-sectional view of an exemplary electronic device that directs displayed information through the electronic device for viewing by a user;

FIG. 2 is a schematic cross-sectional view of another exemplary electronic device that directs displayed information through the electronic device for viewing by a user;

FIG. 3 is a schematic cross-sectional view of another exemplary electronic device that directs displayed information through the electronic device for viewing by a user;

FIG. 4 is a schematic cross-sectional view of another exemplary electronic device that directs displayed information through the electronic device for viewing by a user;

FIG. 5 is a schematic cross-sectional view of another exemplary electronic device that directs displayed information through the electronic device for viewing by a user;

FIG. 6 is a schematic cross-sectional view of another exemplary electronic device that directs displayed information through the electronic device for viewing by a user;

FIG. 7 is a schematic cross-sectional view of another exemplary electronic device that directs displayed information through the electronic device for viewing by a user;

FIG. 8 is a schematic cross-sectional view of another exemplary electronic device that directs displayed information through the electronic device for viewing by a user;

FIG. 9 is a schematic block diagram of a mobile telephone that may include components to direct displayed information through the mobile telephone for viewing by a user; and

FIG. 10 is a schematic diagram of a communications system in which the mobile telephone of FIG. 9 may operate.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the illustration and description of a mobile telephone is not the only context in which various disclosed features may be employed. Other electronic devices that may include various embodiments and/or combinations of disclosed features include, but are not limited to, media players, gaming devices, computers, pagers, communicators, electronic organizers, personal digital assistants (PDAs), and smartphones.

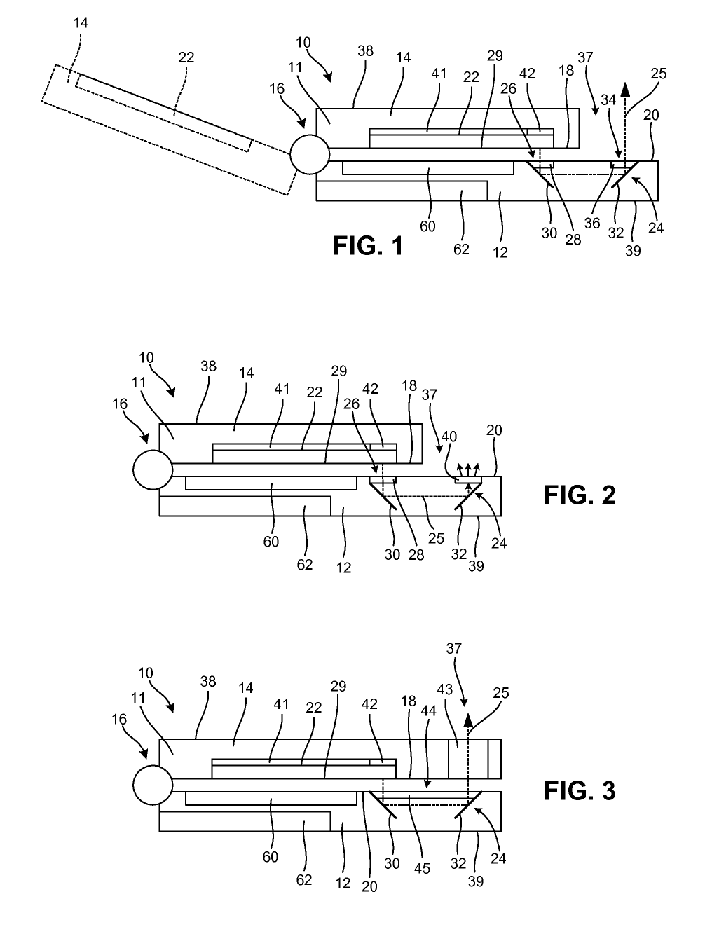

Referring initially to FIG. 1, an electronic device 10 is shown. The electronic device 10 is arranged to have a closed configuration and an open configuration. In the illustrated embodiment, the electronic device 10 is shown as having “flip-open” form factor, which is also referred to as a “clamshell” form factor. In this configuration, the electronic device 10 has a housing 11 that includes a first housing section 12 and a second housing section 14. The sections 12, 14 are pivotally connected to one another at respective proximal ends by a hinge assembly 16. For the illustrated flip-open embodiment, the closed configuration may be achieved by positioning an inner surface 18 of the second housing section 14 adjacent to an inner surface 20 of the first housing section 12. The closed configuration is illustrated in FIG. 1 using solid lines for the second housing section 14. In the illustrated embodiments, the inner surfaces 18, 20 are shown as being slightly spaced apart. It will be appreciated, however, that some or all of the inner surfaces 18, 20 may contact each other when the electronic device 10 is in the closed configuration. The open configuration may be achieved by separating the inner surfaces 18, 20 one another, such as by rotating the second housing section 14 with respect to first housing section 12. The open configuration is illustrated in FIG. 1 using broken lines for the second housing section 14.

A display 22 may be retained by the second housing section 14. The display 22 may be positioned with respect to the inner surface 18 so as to face the inner surface 20 of the first housing section 12 when the electronic device 10 is in the closed configuration. In this manner, when the electronic device 10 is in the closed configuration, the display 22 may be covered by the first housing section 12 and not directly viewable by a user. When the second housing section 14 is positioned with respect to the first housing section 12 so that the electronic device 10 is in the open configuration, the display 22 may be directly viewable by the user.

The illustrated flip-open configuration is intended to be an example of an electronic device that has a display that is covered by a portion of the electronic device when the electronic device is in a closed configuration and uncovered when in an open configuration. Other physical arrangements are possible to result in an electronic device with a display that is covered by a portion of the electronic device when the electronic device is in a closed configuration and uncovered when in an open configuration. One such alternative arrangement is a slide-type form factor, which is also referred to as a “slider” form factor. For instance, slider form factor electronic devices may have, for example, a first housing section and a second housing section that move relative to one another in parallel planes. The movement of one of the housing sections relative to the other housing section may be a linear movement or a rotating movement.

There may be times when it is desirable to display information to a user of the electronic device 10 even when the electronic device 10 is in a closed position. One exemplary situation may be when an incoming call is received by the electronic device 10. In this situation, it may be desirable to display a telephone number or name associated with the incoming call so that the user may decide whether to answer the incoming call. Similarly, it also may be desirable to display information related to received messages (e.g., electronic mail messages, text messages, multimedia messages, etc.). Other information for display when the electronic device is in the closed configuration may include the date, the time, signal strength, battery condition, menu options, appointment reminders and any other displayable text or graphic.

The electronic device 10 is configured to display information on the display 22. The display of information results in the emission of light from an image surface 29 of the display 22. The electronic device 10 is further configured to direct the emitted light through at least one portion of the electronic device 10 for viewing by the user without repositioning of one or both of the housing sections 12, 14. FIG. 1 illustrates one exemplary embodiment of this configuration. Other exemplary embodiments are illustrated in subsequent figures. It will be appreciated that other configurations that fall within the scope of the appended claims are possible. It will also be appreciated that features that are described and/or illustrated with respect to one embodiment may be used in the same way or in a similar way in one or more other embodiments, and/or in combination with or instead of the features of the other embodiments. Therefore, a feature from one embodiment may be added to another embodiment or replace a feature of the other embodiment, even if the other embodiment is not described or illustrated as including that feature.

In the embodiment of FIG. 1, the first housing section 12 may include a mirror assembly 24 to redirect light emitted by the display 22. The light is represented by arrow 25. Light 25 from the display 22 may enter the first housing section 12 through an aperture 26. The opening 26 may be covered by a window 28. The window 28 may be a plane piece of plastic or glass to act as a protective cover for the mirror assembly 24. In other embodiments, the window 28 may have optical qualities, such as having a lens structure to magnify the appearance of the light that is emitted from the display 22. After entering the first housing section 12, the light may become incident on the mirror assembly 24.

In the embodiment of FIG. 1, the mirror assembly 24 includes a first mirror 30 that redirects the light. For instance, the light incident on the first mirror 30 may be transverse to a longitudinal axis of the first housing section 12 and the first mirror 30 may redirect the light in a pathway along the longitudinal axis of the first housing section. The mirror assembly 24 of the illustrated embodiment includes a second mirror 32 to again redirect the light. In the illustrated embodiment, the light is redirected by the second mirror 32 out of the inner surface 20 of the first housing section 12 for viewing by the user. The light may exit the first housing section 12 from an aperture 34. The second mirror 32 and the aperture 34 are positioned in an area that is not covered by the second housing section 14. In this manner, an image displayed on the display 22 may be directed through and emitted from the electronic device 10 for viewing by the user. Similar to the aperture 26, the aperture 34 may be covered by a window 36 or other optical element (e.g., a lens). In another embodiment, the apertures 26, 34 and/or the windows 28, 36 may be combined so that there is a single opening through which the light from the display 22 enters and exits the first housing section 12. In other embodiments, a lens or lenses may be placed between the mirrors 30 and 32.

In the illustrated embodiment, the light is directed out of the electronic device 10 in a direction generally opposite the orientation of the display 22 when the electronic device 10 is in the closed configuration. For many electronic devices 10, this direction of the reflected light pathway may be viewable when a user looks at a front side of the electronic device. That is, for many electronic devices 10, an outer surface 38 of the second housing section 14 and the inner surface 20 of the first housing section 12 may be considered to face forward. In another embodiment, the second mirror 32 may be positioned and oriented to redirect light in another direction, such as out of an aperture in an outer surface 39 of the first housing section 12.

In the arrangement of FIG. 1, the user, in effect, views (e.g., “looks at”) the display 22 through the first housing section 12 by way of an optical system 37. As illustrated in FIG. 2, in another embodiment, the light 25 from the display 22 may be directed to become incident on a viewing surface 40. For instance, the window 34 may be made from or replaced by frosted glass or other material that creates the viewing surface 40. In this alternative, light from the display 22 is, in effect, projected onto the viewing surface 40 and the user views the displayed information as cast onto the viewing surface 40.

In the embodiments of FIGS. 1 and 2, and in other embodiments described below, the display 22 may be capable of generating an image and emitting light over an area that this larger than the area of emitted light that may be directed through the electronic device 10 for viewing by the user. Therefore, to conserve battery power, a portion of the display 22 corresponding to light that is directable through the electronic device 10 may be activated when the electronic device operates in the closed configuration. For instance, pixels of the display 22 that may not produce viewable light when the electronic device 10 is in the closed configuration may not be driven. In one embodiment, the display 22 may be a backlit device, such as a liquid crystal display (LCD). The light source for the backlighting may be segmented into a first light source 41 for use when the electronic device 10 is in the open configuration and a second light source 42 for use when then the electronic device 10 is in either the closed configuration or the open configuration.

Also, when operating in the closed configuration, the display 22 may be controlled to display information (e.g., text and/or graphics) in an orientation appropriate for viewing by the user. For example, the displayed information may be presented backwards on the image surface of the display. In this manner, if the light emitted from the display 22 is reflected an odd number of times, the reflected light may appear as a forward image to the user. Also, when operating in the closed configuration, the display 22 may be controlled to display information in an upside down manner relative to the manner in which information is displayed when operating in an open configuration. Displaying information in an upside down manner may orient the information in a desired direction, depending on the arrangement of the mirrors, the number of times the light is reflected, and the orientation in which it is contemplated that the electronic device 10 will be held or viewed by the user. In addition, the display 22 and the mirror assembly 24 may be respectively arranged to achieve a desired viewing angle for the reflected image.

The embodiment of FIG. 3 is similar to the embodiment of FIG. 1 in that light is emitted from the display 22 and directed through the first housing section 12. Using the mirror assembly 24, the light is directed out of the first housing section 12 and toward the second housing section 14. In the embodiment of FIG. 3, the second housing section is sized to cover the area of the first housing section from which the redirected light emanates. But the second housing section 14 may include an aperture, or viewing channel 43, to allow passage of the light for viewing of the displayed information. For example, when the electronic device is in the closed configuration the channel 43 may be optically aligned with the second mirror 32 of the mirror assembly 24. In this manner, the light may enter the channel 43 through the inner surface 18, travel through the second housing section 14 and exit through the outer surface 38 for viewing by the user. Alternatively, the light may be incident on a viewing surface retained by the second housing section 14.

The channel 43 may include a window or windows to cover the passageway in the second housing section 14 formed by the channel 43. The channel 43 may include a lens or lenses for magnifying the appearance of the displayed information. One or more lenses may serve as both a magnifying device and a protective window. The channel 43 also may include mirrors for further redirecting of the light.

The embodiment of FIG. 3 illustrates a single aperture 44 in the first housing section 12 that serves as the light ingress aperture 26 and the light egress aperture 34 that are present in the embodiment of FIG. 1. Also, a single window 45 is present to cover the combined aperture in this embodiment.

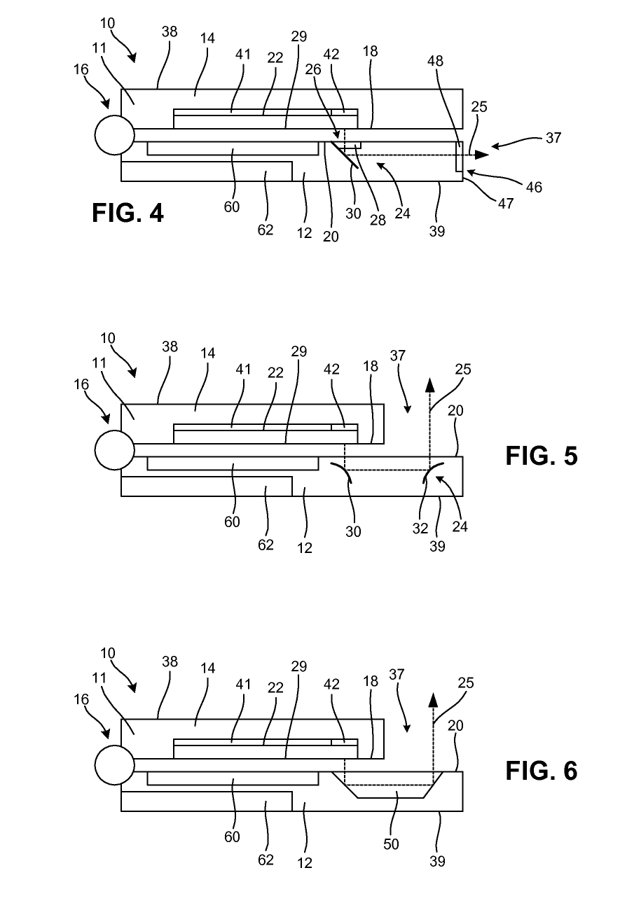

Turning to the embodiment of FIG. 4, the electronic device 10 includes a similar arrangement to the embodiments of FIGS. 1 and 3, but the mirror assembly 24 does not include the second mirror 32. The first mirror 30 may redirect light from the display along the longitudinal axis of the first housing section 12. In the illustrated embodiment, the light travels through the first housing section 12 and out of an aperture 46 in a distal end 47 of the first housing section 12 for viewing by the user. The light may alternatively be redirected toward and out of the proximal end of the first housing section 12 (e.g., the end of the first housing section 12 connected to or adjacent to the hinge assembly 16).

The distal end 47 of the first housing section 12 may include a window 48 through which the light 25 exits the electronic device 10. The window 48 may be combined with the window 28 to form a single block of light transmissive material through which the light enters and exits the first housing section 20. A lens or lenses may be added or used in place of one or both of the windows 28, 48 to magnify the appearance of the displayed information. Also, the window 48 may be replaced with a viewing surface upon which the light 25 may be incident for viewing by the user.

As indicated above, the orientation of the displayed information may be arranged to facilitate viewing of the displayed information as represented by the light that is emitted from the electronic device 10. For instance, in the embodiment of FIG. 4 where the light is reflected once, the display 22 may be controlled to display the image in a backwards and/or upside down configuration.

FIG. 5 illustrates an embodiment similar to the embodiment of FIG. 1, but where the mirrors 30 and 32 are curved to enlarge the appearance of the displayed information that is emitted from the electronic device 10 in the form of the light 25. It will be understood that one of the mirrors 30, 32 may be a planar reflecting surface and the other of the mirrors 30, 32 may be a curved reflecting surface. Windows, lens and any other appropriate components may be placed in the light pathway through the electronic device 10.

The various embodiments have been described as employing mirrors as reflecting surfaces to redirect the light 25. Also, the embodiments have been described as employing curved reflecting surfaces and/or a lens system to enlarge the displayed information. It will be understood that alternative components and techniques may be used for these tasks.

For instance, turning to the embodiment of FIG. 6, a Porro prism 50 may be used to magnify the image and to change the direction of the light 25 while shifting the position of the light output relative to the position of the light input. It will be appreciated that other prism arrangements may be used for some or all of these tasks. As such, any appropriate combination of reflecting surfaces (including surfaces that redirect light using total internal reflection) and/or magnifying components may be used to assist in achieving a desired light pathway through the electronic device 10 for viewing of displayed information when the electronic device 10 is in a closed configuration.

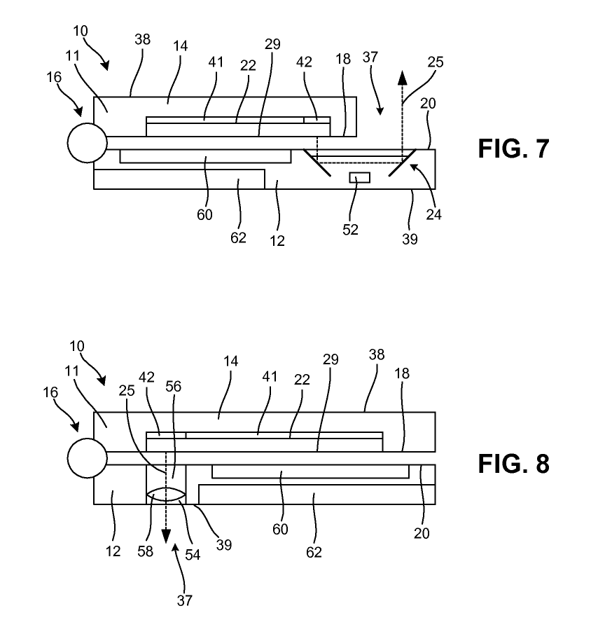

Turning to the embodiment of FIG. 7, the illustrated embodiment is similar to the embodiment of FIG. 1. In order to create an optical pathway for the light to travel in an unobstructed manner, a portion of the volume inside the electrical device 10 is relatively free from objects. It has been found that performance of a mobile telephone may be enhanced if an antenna 52 used to establish an operative wireless link is positioned in a volume of the mobile telephone that is relatively clear of other objects that may electromagnetically load the antenna 52 beyond an acceptable amount. In the embodiment of FIG. 7, the antenna 52 is positioned adjacent to the mirror assembly 24 so that a relatively unobstructed optical pathway for the light 25 is shared with a volume surrounding the antenna 52 that is clear of substantial electromagnetic loads. It is noted that one or both of these volumes may be void of any materials or may include materials that are transparent to the light 25 and/or substantially non-loading to the antenna 52. In this manner, volume within the electronic device 10 may be efficiently allocated.

Turning to FIG. 8 another exemplary embodiment of the electronic device 10 that directs displayed information through the electronic device 10 for viewing by the user is shown. In this embodiment, light emitted from the display is directed through a channel 54 in the first housing section 12. For example, when the electronic device is in the closed configuration the channel 54 may be optically aligned with the portion of the display 22 used to generate the displayed information. In this manner, the light may enter the channel 54 through the inner surface 20, travel through the first housing section 12 and exit through the outer surface 39 for viewing by the user. Alternatively, the first housing section 12 may retain a viewing surface upon which the light 25 may be incident for viewing by the user.

The channel 54 may include a window 56 or windows to cover the passageway in the first housing section 12 formed by the channel 54. The channel 54 may include a lens 58 or lenses for magnifying the appearance of the displayed information. One or more lenses also may serve as the window 56 to reduce the number of optical components. The channel 54 also may include mirrors for further redirecting of the light.

The electronic devices 10 of the illustrated and described embodiments each include the display 22 and an optical system 37 that is arranged so that displayed information may be viewed by the user when the electronic device 10 is in a closed configuration and a housing member covers the display 22. As indicated, the optical system 37 may include any appropriate combination of components including, but not limited to, reflecting surfaces, windows, lenses, and viewing surfaces.

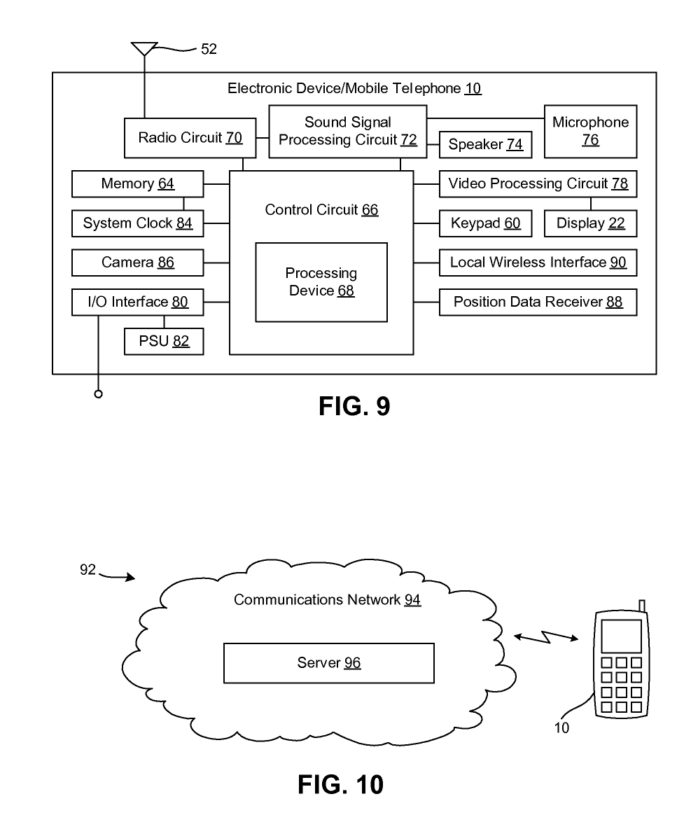

As will be appreciated, the electronic device 10 may include additional components. For instance, in the illustrated embodiment, a keypad 60 is present. Also present may be a battery assembly 62 to supplying electrical power to various electrical components of the electronic device 10. Additional exemplary components that may be present are described below in connection with FIG. 9.

With additional reference to FIG. 9, a block diagram of components for the electronic device 10 when the electronic device 10 is configured as a mobile telephone are illustrated. As indicated above, the electronic device 10 may be another type of device or another type of mobile telephone and may include a different compliment of components than those illustrated. For the sake of brevity, many features of the electronic device 10 will not be described in great detail.

As indicated, the electronic device 10 may include the display 22. The display 22 displays information to a user such as operating state, time, telephone numbers, contact information, menus, etc., that enable the user to utilize the various features of the electronic device 10. The display 22 also may be used to visually display content received by the electronic device 10 and/or retrieved from a memory 64 of the electronic device 10. The display 22 may be used to present images, video and other graphics to the user, such as photographs, mobile television content and video associated with games.

The keypad 60 provides for a variety of user input operations. For example, the keypad 60 may include alphanumeric keys for allowing entry of alphanumeric information such as telephone numbers, phone lists, contact information, notes, text, etc. In addition, the keypad 60 may include special function keys such as a “call send” key for initiating or answering a call, and a “call end” key for ending or “hanging up” a call. Special function keys also may include menu navigation and select keys to facilitate navigating through a menu displayed on the display 22. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 60. Also, the display 22 and keypad 60 may be used in conjunction with one another to implement soft key functionality.

The electronic device 10 includes call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 64, executing applications to allow user interaction with the data, displaying video and/or image content associated with the data, outputting audio sounds associated with the data, and so forth.

The electronic device 10 includes a primary control circuit 66 that is configured to carry out overall control of the functions and operations of the electronic device 10. The control circuit 66 may include a processing device 68, such as a central processing unit (CPU), microcontroller or microprocessor. The processing device 68 executes code stored in a memory (not shown) within the control circuit 66 and/or in a separate memory, such as the memory 64, in order to carry out operation of the electronic device 10. The memory 64 may be, for example, one or more of a buffer, a flash memory, a hard drive, a removable media, a volatile memory, a non-volatile memory, a random access memory (RAM), or other suitable device. In a typical arrangement, the memory 64 may include a non-volatile memory (e.g., a NAND or NOR architecture flash memory) for long term data storage and a volatile memory that functions as system memory for the control circuit 66. The volatile memory may be a RAM implemented with synchronous dynamic random access memory (SDRAM), for example. The memory 64 may exchange data with the control circuit 66 over a data bus. Accompanying control lines and an address bus between the memory 64 and the control circuit 66 also may be present.

In addition, the processing device 68 may execute code that implements various functions of the electronic device 10. It will be apparent to a person having ordinary skill in the art of computer programming, and specifically in application programming for mobile telephones or other electronic devices, how to program a electronic device 10 to operate and carry out various logical functions. Also, while functions of the electronic device 10 may be executed by the processing device 68 in accordance with an embodiment, such functionality could also be carried out via dedicated hardware or firmware, or some combination of hardware, firmware and/or software.

Continuing to refer to FIG. 9, the electronic device 10 may include the antenna 52, which is coupled to a radio circuit 70. The radio circuit 70 includes a radio frequency transmitter and receiver for transmitting and receiving signals via the antenna 52. As will be appreciated, the antenna 52 and the radio circuit 70 may represent one or more than one radio transceiver. The radio circuit 70 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards.

The electronic device 10 further includes a sound signal processing circuit 72 for processing audio signals transmitted by and received from the radio circuit 70. Coupled to the sound processing circuit 72 are a speaker 74 and a microphone 76 that enable a user to listen and speak via the electronic device 10 as is conventional. The radio circuit 70 and sound processing circuit 72 are each coupled to the control circuit 66 so as to carry out overall operation. Audio data may be passed from the control circuit 66 to the sound signal processing circuit 72 for playback to the user. The audio data may include, for example, audio data from an audio file stored by the memory 64 and retrieved by the control circuit 66, or received audio data such as in the form of streaming audio data or audio data from a mobile radio service. The sound processing circuit 72 may include any appropriate buffers, decoders, amplifiers and so forth.

The display 22 may be coupled to the control circuit 66 by a video processing circuit 78 that converts video data to a video signal used to drive the display 22. The video processing circuit 78 may include any appropriate buffers, decoders, video data processors and so forth. The video data may be generated by the control circuit 66, retrieved from a video file that is stored in the memory 64, derived from an incoming video data stream that is received by the radio circuit 70 or obtained by any other suitable method.

The electronic device 10 may further include one or more I/O interface(s) 80. The I/O interface(s) 80 may be in the form of typical electronic device I/O interfaces and may include one or more electrical connectors. As is typical, the I/O interface(s) 80 may be used to couple the electronic device 10 to a battery charger to charge the battery 62, which forms part of a power supply unit (PSU) 82 within the electronic device 10. In addition, or in the alternative, the I/O interface(s) 80 may serve to connect the electronic device 10 to a headset assembly (e.g., a personal handsfree (PHF) device) that has a wired interface with the electronic device 10. Further, the I/O interface(s) 80 may serve to connect the electronic device 10 to a personal computer or other device via a data cable for the exchange of data. The electronic device 10 may receive operating power via the I/O interface(s) 80 when connected to a vehicle power adapter or an electricity outlet power adapter. The PSU 82 may supply power to operate the electronic device 10 in the absence of an external power source.

The electronic device 10 also may include a system clock 84 for clocking the various components of the electronic device 10, such as the control circuit 66 and the memory 64.

The electronic device 10 may include a camera 86 for taking digital pictures and/or movies. Image and/or video files corresponding to the pictures and/or movies may be stored in the memory 64.

The electronic device 10 also may include a position data receiver 88, such as a global positioning system (GPS) receiver, Galileo satellite system receiver or the like. The position data receiver 88 may be involved in determining the location of the electronic device 10.

The electronic device 10 also may include a local wireless interface 90, such as an infrared transceiver and/or an RF interface (e.g., a Bluetooth interface), for establishing communication with an accessory, another mobile radio terminal, a computer or another device. For example, the local wireless interface 90 may operatively couple the electronic device 10 to a headset assembly (e.g., a PHF device) in an embodiment where the headset assembly has a corresponding wireless interface.

With additional reference to FIG. 10, the electronic device 10 may be configured to operate as part of a communications system and 92. The system 92 may include a communications network 94 having a server 96 (or servers) for managing calls placed by and destined to the electronic device 10, transmitting data to the electronic device 10 and carrying out any other support functions. The server 96 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 94 may support the communications activity of multiple mobile telephones 10 and other types of end user devices. As will be appreciated, the server 96 may be configured as a typical computer system used to carry out server functions and may include a processor configured to execute software containing logical instructions that embody the functions of the server 96 and a memory to store such software.

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
a display for displaying information;
a housing having a first section and a second section, the housing sections movable with respect to one another such that the electronic device has an open configuration and a closed configuration, wherein the second housing section retains the display and the first housing section covers an image surface of the display when the electronic device is in a closed configuration; and
an optical system arranged with respect to the display to allow a user of the electronic device to view the displayed information through the housing when the electronic device is in the closed configuration.

2. The electronic device of claim 1, wherein light from the display enters the first housing section through an inner surface of the first housing section and the optical system includes a least one reflecting surface retained by the first housing section to redirect the light from the display, the redirected light exiting the first housing section for viewing by the user.

3. The electronic device of claim 2, wherein the optical system includes two reflecting surfaces retained by the first housing section such that light from the display is directed out of the first housing section through the inner surface of the first housing section.

4. The electronic device of claim 3, wherein the light that is directed out of the first housing passes through an optical channel of the second housing section.

5. The electronic device of claim 2, wherein the at least one reflecting surface is a mirror or mirrors.

6. The electronic device of claim 2, wherein the at least one reflecting surface is a prism or prisms.

7. The electronic device of claim 6, wherein the at least one reflecting surface is comprised of a Porro prism.

8. The electronic device of claim 2, wherein the at least one reflecting surface includes a curved reflecting surface to enlarge an appearance of the displayed information.

9. The electronic device of claim 2, wherein the optical system includes an optical element to enlarge an appearance of the displayed information.

10. The electronic device of claim 2, wherein the optical system includes a window through which the light passes to enter the first housing section.

11. The electronic device of claim 10, wherein the light is directed out of the first housing section through the window.

12. The electronic device of claim 10, wherein the optical system includes a second window through which the light is directed out of the first housing section.

13. The electronic device of claim 1, wherein light from the display enters the first housing section through an inner surface of the first housing section and is directed by the optical system to be incident on a viewing surface for viewing by the user.

14. The electronic device of claim 13, wherein the optical system includes an optical element to enlarge an appearance of the displayed information.

15. The electronic device of claim 1, wherein light from the display enters the first housing section through an inner surface of the first housing section, traverses the first housing section through a channel and exits the first housing section through an outer surface of the first housing section.

16. The electronic device of claim 15, wherein the optical system is retained in the channel and includes an optical element to enlarge an appearance of the displayed information.

17. The electronic device of claim 1, wherein the display includes a segmented light source having a first light source segment that provides light when the electronic device is in the open configuration and does not provide light when the electronic device is in the closed configuration and a second light source segment that provides light when the electronic device is in both the open and closed configurations.

18. The electronic device of claim 1, wherein the display is controlled to display information in an orientation that is coordinated with the optical system such that the displayed information has a forward appearance when viewed by the user.

19. The electronic device of claim 1, wherein the electronic device is a mobile telephone and includes circuitry for establishing a call over a network.

20. The electronic device of claim 19, wherein the circuitry includes an antenna and the antenna is positioned adjacent to the optical system so that an optical pathway for light from the display is shared with a volume surrounding the antenna that is clear of substantial electromagnetic loads.
